(19) United States
(12) Patent Application Publication
(10) Pub. No.: US 2024/0224889 A1
(43) Pub. Date: Jul. 11, 2024

(54) MESOPOROUS SOLID FOR CONTROLLING HUMIDITY IN ENCLOSED SPACES

(71) Applicants: UNIVERSITE CLAUDE BERNARD LYON 1, Villeurbanne (FR); CENTRE NATIONAL DE LA RECHERCHE SCIENTIFIQUE (CNRS), Paris (FR)

(72) Inventors: Melaz TAYAKOUT-FAYOLLE, Lyon (FR); Elsa JOLIMAITRE, Lyon (FR)

(73) Assignees: UNIVERSITE CLAUDE BERNARD LYON 1, Villeurbanne (FR); CENTRE NATIONAL DE LA RECHERCHE SCIENTIFIQUE (CNRS), Paris (FR)

(21) Appl. No.: 18/289,512

(22) PCT Filed: May 4, 2022
(86) PCT No.: PCT/FR2022/050862

§ 371 Date: Nov. 3, 2023

(30) Foreign Application Priority Data
May 4, 2021 (FR) FR2104712

(51) Int. Cl. A01G 9/24; B01D 53/26

(52) U.S. Cl. CPC A01G 9/246; B01D 53/261; B01D 2221/06; B01D 2221/16; B01D 2253/102; B01D 2253/1124; B01D 2253/308; B01D 2253/311

(57) ABSTRACT

The present disclosure relates to the use of mesoporous solids to control relative humidity in enclosed spaces while greatly reducing energy expenditure. The mesoporous solids are particularly suitable for controlling relative humidity in greenhouses.

### FIELD OF THE INVENTION

The present invention relates to the use of mesoporous solids for controlling relative humidity in enclosed spaces in order to greatly reduce energy expenditure.

Mesoporous solids are particularly suitable for controlling relative humidity in greenhouses.

### TECHNICAL BACKGROUND

Humidity control is a major challenge for various types of buildings and other enclosed spaces. The term enclosed space means a totally or partially closed space.

A partially closed space can therefore contain openings to the outside, allowing occasional or limited passage of air.

In agricultural greenhouses, humidity control is essential for optimising production. More specifically, the quantity and quality of cultivated plants depends on the climatic conditions in the greenhouse during their growth. One of the key parameters is the relative humidity, or hygrometry, defined as the ratio between the moisture content in the air and the saturation moisture content at the temperature of the greenhouse. The optimum relative humidity depends on the plant cultivated and its growth phase (cutting, young plant, flowering, etc.). Furthermore, too high a relative humidity can lead to condensation of water at the surface of the plant; which is conducive to the development of diseases and must therefore be avoided absolutely.

The two main means used for controlling relative humidity are heating and (natural and/or forced) ventilation. Ventilation exchanges the air in the greenhouse with less humid external air. The implementation of these two techniques has the major disadvantage of being very energy consuming. Indeed, ventilation with colder external air leads to a significant loss of thermal energy, which must be compensated by heating. In addition, ventilation cannot efficiently reduce the humidity in the greenhouse when the moisture content of the outside air is very high, for example when it is raining.

Various techniques have been proposed to overcome these various problems, such as those described in the article by M. Amani et al. (Comprehensive review on dehumidification strategies for agricultural greenhouse applications, Applied Thermal Engineering, Volume 181, 2020, 115979).

The two dehumidification techniques best known to a person skilled in the art are thermodynamic dehumidification and the use of desiccant wheels.

The principle of thermodynamic dehumidifiers is to circulate the air of the greenhouse by forced ventilation through a cold coil, in order to condense part of the moisture in the air, then through a hot coil, in order to reheat the dehumidified air before reinjection into the greenhouse. The cooling and heating of the coils are provided by a heat transfer fluid, which is condensed at the inlet of the cold coil and vaporised at the inlet of the hot coil. This type of system can control humidity effectively, but at high cost: in addition to the initial investment, the electrical energy required for operation of the condenser is significant.

Another technique that have been used for many years for dehumidifying is the desiccant wheel. A solid or liquid desiccant medium is placed in a wheel which undergoes a continuous rotation movement. A first fan enables air coming from the greenhouse to be injected onto the desiccant, in order to dry the air before its reinjection into the greenhouse. A second fan draws in the outside air, circulates it in a heating system and then through the wheel in order to regenerate the desiccant. Through rotation of the wheel, the desiccant is successively in contact with the air of the greenhouse (adsorption phase) and with the hot outside air (desorption or regeneration phase). The preferred media for this type of dehumidifiers are those which capture moisture at very low humidity levels, such as certain silica gels, molecular sieves, for example zeolites, or saline solutions. Desiccant wheels find little use in greenhouses because they have several major disadvantages: the system is complex to implement and its installation is expensive and regeneration by heating requires high energy expenditure.

Patent KR100890574 proposes using an adsorbent zeolite in order to dehumidify the air of greenhouses. The zeolite is placed in a cylinder outside the greenhouse. During the night, air from the greenhouse is injected into the cylinder and the moisture is absorbed in the zeolite. During the day, the zeolite is regenerated using the outside air. Since the zeolite requires very dry air in order to be regenerated, the patent specifies that the system can only operate in certain climates, for which the relative humidity is very low during the day (20-40%).

Humidity control is not only essential in greenhouses. Humidity control problems can affect a large variety of enclosed spaces, such as residential buildings, buildings for tertiary or industrial use, or transport buildings. In buildings for residential, tertiary or industrial use, the control of humidity is necessary in order to ensure the comfort of the occupants and to avoid degradation of the buildings and production materials. Here also the two main techniques used are heating and natural ventilation (air inlets) or controlled mechanical ventilation (CMV) which cause significant heat losses. For residences, there are also mineral salt based desiccators (generally calcium chloride), which absorb the humidity of the air and reject it in the form of water into a tank which must be regularly emptied. Desiccant wheels are sometimes used in large industrial buildings, with the same disadvantages as for agricultural greenhouses. When the air is too dry, air humidifiers are used.

Metal-organic framework solids (commonly designated MOF) have been proposed for controlling the humidity in enclosed spaces (see, for example, Menghao Qin, Pumin Hou, Zhimin Wu, Juntao Wang, Precise humidity control materials for autonomous regulation of indoor moisture, Building and Environment, Volume 169, 2020).

MOF are microporous solids, which also have many disadvantages. In addition to the fact that they are complex to synthesise and to shape in order to form granules, their synthesis most often requires the use of solvents that are hazardous to health, such as N,N-dimethylformamide. Moreover, their structure is generally unstable both thermally and in the presence of water (see Karen Leus, Thomas Bogaerts, Jeroen De Decker, Hannes Depauw, Kevin Hendrickx, Henk Vrielinck, Veronique Van Speybroeck, Pascal Van Der Voort, Systematic study of the chemical and hydrothermal stability of selected “stable” Metal Organic Frameworks, Microporous and Mesoporous Materials, Volume 226, 2016, Pages 110-116), which is particularly problematic for their use in potentially very humid spaces.

Hall M R et al. (Acta Materialia 60 (2012) 89-101) discloses desiccant materials, in particular mesoporous silicas. The proposed materials have a total macroporous and mesoporous volume greater than that of the materials of the present invention and too large a volume percentage of macropores relative to the volume of macropores and micropores.

EP 3 042 877 describes porous carbon-based adsorbent materials. Their capacity to control humidity is not described. Furthermore, the proposed materials have micropores (0.3 mL/g to 0.7 mL/g) whereas the materials of the present invention are substantially free of such micropores.

JP 2002/284520 describes silica-alumina-based mesoporous materials. Apart from the diameter of the mesopores, little information is given on the structure of the materials. Nevertheless, it should be noted that materials having mesopores for which the diameter is less than 10 nm can control humidity over a range from 75 to 90% humidity, while the materials of the present invention having mesopores for which the diameter is less than 10 nm, can control humidity over a range from 40 to 60% humidity. The materials described in JP 2002/284520 therefore do not have all of the features of the materials of the present invention.

Tomita Yumiko et al. (Journal of the Ceramic Society of Japan 112(9) 491-495) disclose porous silica monoliths having a bimodal pore distribution. The proposed materials have a macroporous volume greater than that of the materials of the present invention or a total macroporous and mesoporous volume greater than that of the materials of the present invention.

Furthermore, none of the four documents just cited above demonstrates the control capacities of the proposed solids. More specifically, only the static adsorption and/or desorption capacities, named water adsorption isotherms, are measured, using measurement devices such as dynamic vapour sorption (DVS) or the use of desiccators. These measurement devices are equipped with independent humidity regulators not using the control capacities of solids. In the case of DVS apparatuses, the relative humidity is controlled by bubbling the incoming air into liquid water at a given temperature. In the case of desiccators, the relative humidity is controlled by placing air in static contact with liquid water which may or may not contain humidity regulating mineral salts. In these apparatuses, solids therefore have no role in the control of relative humidity. The dynamic and passive control properties of these solids cannot therefore be measured and demonstrated.

Hence, a need remains for the provision of a technique that can control the relative humidity in enclosed spaces, which does not have the disadvantages of the proposed solutions, in particular for the provision of a technique that does not require, or requires little, energy. It is understood that the proposed solution will not have risks for the environment and for human health. Furthermore, the proposed solution will occupy a minimum of volume in the enclosed space so as not to disturb the users and/or the various functions associated with the enclosed space, such as the cultivation of plants.

### SUMMARY

The invention relates to the use of a mesoporous solid for controlling relative humidity in an enclosed space. The mesoporous solid has:
mesopores, the mean diameter of which varies from 3 to 50 nm as measured by nitrogen adsorption combined with the BJH method according to standard ASTM D4641-17;
a mesoporous volume greater than or equal to 0.2 mL/g as measured by nitrogen adsorption combined with the BJH method according to standard ASTM D4641-17; and
a ratio between the mean diameter of the mesopores as measured by nitrogen desorption and as measured by nitrogen adsorption ([desorption mean diameter]/[adsorption mean diameter]) ranging from 0.3 to 1;
   wherein when the mesoporous solid also comprises macropores, micropores or micropores and macropores:
the total macroporous and mesoporous volume varies from 0.3 to 2 mL/g;
the ratio (macroporous volume)/(total macroporous and mesoporous volume) is less than 0.6; and
the microporous volume is less than 0.2 mL/g.

The invention also relates to a device for controlling the relative humidity in an enclosed space comprising:
a container, preferably a container made of a material that is impermeable to the air and provided with one or more openings intended to be connected to the atmosphere of the enclosed space;
a mesoporous solid, as described here, disposed in the container.

The invention also relates to a process for controlling the relative humidity in an enclosed space comprising one of the following steps:
(a1) placing the mesoporous solid as described here, inside the enclosed space; or
(a2) placing the mesoporous solid as described here in one or more containers made of material that is impermeable to air and provided with openings connected to the atmosphere of the enclosed space inside the enclosed space; or
(a3) placing one or more devices according to the invention inside the enclosed space; or
(a4) placing the mesoporous solid as described here in one or more surfaces of the enclosed space.

Other aspects of the invention are as described below in the claims.

### DETAILED DESCRIPTION

It has surprisingly been found that certain mesoporous solids can control relative humidity in enclosed spaces, while strongly reducing energy expenditure. These mesoporous solids are all particularly suitable for controlling relative humidity in greenhouses.

Thus, the present invention relates to the use of mesoporous solids for controlling the relative humidity in enclosed spaces, to the processes using these mesoporous solids, as well as to devices incorporating these mesoporous solids.

The term “mesoporous solid” designates a solid having, within its structure, pores for which the mean diameter varies from 2 to 50 nanometres, designated as “mesopores”.

By “controlling”, it is meant that the mesoporous solids can capture the moisture in the air when the relative humidity of the air exceeds a desired maximum value and release it spontaneously once the relative humidity of the air is below a desired minimum value. The control is possible without the addition of external energy. Thus, in other words, the mesoporous solids of the present invention can automatically control the relative humidity in enclosed spaces, i.e. control the relative humidity without outside intervention, for example without the addition of external energy, without a control device and without instruction. Nevertheless, in some embodiments, it may be desired to add external energy. The terms “controlling” and “automatically controlling” may be used here indifferently and interchangeably. Furthermore, this capacity to control the relative humidity of the air implies that the mesoporous solids used in the context of the present invention are stable in the presence of water, in other words that their porous properties are not altered in the presence of water. The stability of mesoporous solids can be evaluated by determining the size distribution of the mesopores by nitrogen porosimetry according to the BJH method (standard ASTM D4641-17) on adsorption and desorption of nitrogen. A variation of the size distribution of mesopores over time reflects an instability of the mesoporous solid. A stable mesoporous solid will therefore have a constant mesopore size distribution over time (for example a constant mesopore size distribution over several months or even several years, for example one month, three months, six months, one year, two years). For crystalline mesoporous solids, the stability of the mesoporous solids can, alternatively, be determined by x-ray diffraction, a technique which enables any change in the crystalline structure of the solid to be detected.

It should be noted that the control performance of a porous solid cannot be evaluated based solely on the water adsorption or desorption properties, because the solid must be able to both capture water when the relative humidity is greater than the desired upper limit and to desorb it below the desired lower limit. In order that the solid is passive, it is necessary that these properties are respected without adding energy, either for adsorption or desorption.

Furthermore, it is well-known that mesoporous solids exhibit adsorption hysteresis for water and that, consequently, the adsorption and desorption properties differ depending on the initial humidity level of solid. Thus, a mesoporous solid that is totally saturated with water will begin to regenerate at a different relative humidity from a solid for which the pores are only partially filled with water.

Consequently, it is not possible to evaluate the control performance, nor even to compare the relative performance of different solids, based solely on the different quantities of water absorbed when the relative humidity increases or the quantities desorbed when the relative humidity decreases.

Finally, the control performance of a porous solid is also dependent on adsorption and desorption kinetics, which must be sufficiently rapid to capture the water in the air at the same moment when the relative humidity exceeds the desired level.

The optimal properties of porous solids for passive control of humidity are therefore very different from those of porous solids used for drying or as desiccants, with or without regeneration. A solid can adsorb large quantities of water and therefore be very useful for drying, but be very difficult to regenerate, for example requiring a very high regeneration energy, which makes it useless for a passive control process. This is, for example, the case for microporous solids in which the water is very strongly absorbed and which therefore requires a large addition of energy for their regeneration.

The term “enclosed space” means a totally or partially closed space. A “partially closed” space, which may also be called “semi-closed”, means a space which can comprise openings to the outside, allowing occasional or limited passage of air.

The volume occupied by the porous solids in enclosed or semi-closed spaces must be as low as possible. Indeed, it is obvious that the solid must be able to be placed in the space without disturbing the users. In the case of agricultural greenhouses, it is desired to reserve as much as possible of the available space for culturing plants and, furthermore, the solid must not obstruct the access to the plants for their maintenance and harvesting. In the case of buildings for residential or professional use, the solid must not disturb movement or more generally reduce the space available for the main activity of these spaces. Furthermore, it is well known (see for example the work of Calas et al., Mechanical Strength Evolution from Aerogels to Silica Glass. Journal of Porous Materials 4, 211-217 (1997) or de Wagh et al., Dependence of ceramic fracture properties on porosity. J Mater Sci 28, 3589-3593 (1993)) that the mechanical strength of porous solids is inversely proportional to the total porous volume.

Consequently, it is desirable to minimise any porous volume that is not active in the control of humidity, in other words all the pores which do not have the features claimed in the present invention. In particular, the volume occupied by the micropores and the macropores must be minimised.

Unlike the solids used in desiccant wheels, the solids used in the context of the present invention do not need to be set in motion and do not need to be placed in contact with a previously heated gas flow in order to be regenerated.

Unlike the zeolites described in KR100890574, the solids used in the context of the present invention do not contain zeolites or any other microporous solid and therefore do not require very dry air in order to be regenerated. Thus, the solids used in the context of the present invention can be adapted to any type of climate.

In general, the size of the pores of porous solids can vary from less than one nanometre to several hundred nanometres. According to the IUPAC definitions, solids are said to be microporous if the size of the pores is less than 2 nanometres, mesoporous between 2 and 50 nanometres and macroporous beyond this. One of the standardised methods (standard ASTM D4641-17 (2017)) for measuring the size distribution of the pores of mesoporous solids is nitrogen sorption combined with the Barrett-Joyner-Halenda model, designated by the acronym BJH, as described in the literature ((E. P. Barrett, L. G. Joyner, P. H. Halenda “The determination of pore volume and area distributions in porous substances. 1. Computations from nitrogen isotherms” Journal of the American Chemical Society, vol 73(1), pages 373-380 (1951)).

Nitrogen sorption isotherms of mesoporous solids are different at adsorption and desorption (hysteresis phenomenon). For a given solid, two pore size distributions for the nitrogen adsorption and desorption branches can therefore be obtained and therefore two mean diameters of pores, one diameter associated with the adsorption branch and the other with the desorption branch. These two diameters are designated respectively below by the terms “adsorption mean diameter” and “desorption mean diameter”.

Surprisingly, it has been discovered that certain mesoporous solids can control the relative humidity in enclosed spaces in a passive manner (without addition of external energy) or with a minimal addition of energy, for example when fans are used in order to transfer the water and the thermal energy from the air to the solid as rapidly as possible. Another minimal addition of energy can also be used to heat the air before placing it in contact with the solid, in order to increase the mass transfer kinetics or to avoid the formation of solid water in the pores. These mesoporous solids can capture the water in the air once the relative humidity exceeds a desired maximum value, but can also release it spontaneously below a certain value of relative humidity, and thus regenerate without the addition of external energy. It has also been discovered that it was possible to control the maximum and minimum humidity level beyond which the solids capture and release water by controlling the size distribution of pores of the solids.

### Characterisation Techniques.

In the present description, when reference is made to the total macroporous and mesoporous volume, this total macroporous and mesoporous volume is measured by mercury intrusion according to standard ASTM D4284-12, at a maximum pressure of 4000 bar. The surface tension is fixed at 484 dyne/cm and the angle of contact at 140°. The macroporous volume is evaluated by subtracting the mesoporous volume measured by mercury intrusion from the total macroporous and mesoporous volume measured by the same method.

In the present description, when reference is made to the mesoporous volume, to the pore size distribution and to the mean diameter of the pores, these parameters are measured by nitrogen porosimetry according to the BJH method (standard ASTM D4641-17). The mesoporous volume is the cumulative volume in all the mesopores with P/P₀=0.96. The mean pore diameter (mean diameter by volume) is evaluated by the equation d=4V/A, where d is the mean diameter, V is the mesoporous volume and A is the cumulative surface in all the mesopores at P/P₀=0.96. The microporous volume is determined by nitrogen porosimetry using the t-plot method by applying standard ISO 15901-2:2022 and by calculating the statistical thickness t using the Harkins-Jura equation.

### Mesoporous Solids

The mesoporous solids used in the context of the present invention are mesoporous solids, having:
mesopores, the mean diameter of which varies from 3 to 50 nm, preferably from 4 to 35 nm, more preferably from 4 to 30 nm, as measured by nitrogen adsorption combined with the BJH method according to standard ASTM D4641-17;
a mesoporous volume greater than or equal to 0.2 mL/g, preferably greater than or equal to 0.4 mL/g, more preferably greater than or equal to 0.5 mL/g, as measured by nitrogen adsorption combined with the BJH method according to standard ASTM D4641-17; and
a ratio between the mean mesopore diameter as measured by nitrogen desorption and as measured by nitrogen adsorption ([desorption mean diameter]/[adsorption mean diameter]) ranging from 0.3 to 1;
   wherein when the mesoporous solids also comprise macropores, micropores or micropores and macropores:
the total macroporous and mesoporous volume varies from 0.3 to 2 mL/g;
the ratio (macroporous volume)/(total macroporous and mesoporous volume) is less than 0.6;

and
the microporous volume is less than 0.2 mL/g.

The mesoporous volume is generally less than 1.7 mL/g, preferably less than 1.6 mL/g, more preferably less than 1.5 mL/g.

The term “mesoporous volume” designates the cumulative volume of the mesopores per unit of solid mass.

The term “macroporous volume” designates the cumulative volume of the macropores per unit of solid mass.

The term “microporous volume” designates the cumulative volume of the micropores per unit of solid mass.

In certain embodiments, the mesoporous solids used in the context of the present invention have mesopores, the mean diameter of which varies from 3 to 50 nm, preferably from 4 to 35 nm, more preferably from 4 to 30 nm, as measured by nitrogen desorption combined with the BJH method according to standard ASTM D4641-17.

In certain embodiments, the mesoporous solids used in the context of the present invention have a ratio between the mean mesopore diameter as measured by nitrogen desorption and as measured by nitrogen adsorption ([desorption mean diameter]/[adsorption mean diameter]) ranging from 0.35 to 1, more preferably from 0.4 to 1, yet more preferably ranging from 0.6 to 1.

In certain embodiments, the mesoporous solids used in the context of the present invention have a total macroporous and mesoporous volume ranging from 0.4 to 1.9 mL/g, preferably 0.5 to 1.8 mL/g as measured by mercury intrusion according to standard ASTM D4284-12.

In order to limit the volume occupied by the porous solids in the enclosed space, the ratio (macroporous volume)/(total macroporous and mesoporous volume) of the solids used in the context of the present invention is less than 0.6, preferably less than 0.55, more preferably less than 0.5.

Micropores are not desired in the context of the present invention, because they require an addition of outside energy in order to be regenerated. It will therefore be desired to minimise the microporous volume. The microporous volume of the solids according to the invention is therefore less than 0.2 mL/g, preferably less than 0.1 mL/g, more preferably less than 0.05 mL/g, or even zero.

It has been observed that the precision of the control, defined as the difference between the desired relative humidity and that measured, is higher when the mesopore size distribution is less dispersed, in other words when the standard deviation of this distribution is low, and this both for the distribution obtained by nitrogen adsorption and desorption. The standard deviation of the mesopore size distribution is therefore preferably less than 150% of the mean diameter, yet more preferably less than 130% of the mean diameter, particularly preferably less than 100% of the mean diameter.

The chemical nature of the mesoporous solids has no or little impact on their performance Nevertheless, the solids chosen are preferably the most stable over time, in other words those for which the porous properties are not degraded in the presence of water vapour and in the case of sudden large variations in temperature. Since metal-organic framework solids are not generally stable in the presence of water, the mesoporous solids used in the context of the present invention are preferably not metal-organic framework solids. Preferably, the solids used in the context of the present invention are selected from the group comprising the metal-oxide-based solids, such as the oxides of silicon, aluminium or mixtures of silicon and aluminium, carbon-based solids, such as active carbon and carbon nanotubes and the mixtures thereof. In certain embodiments, the solids used in the context of the present invention are selected from the group comprising the silicon oxide-based solids, aluminium oxide-based solids and carbon-based solids. Mixtures of various solids and/or crystalline phase can be used, in particular, in order to improve the performance of the solid and/or the stability of the performance over time.

It is possible that, over time and with use, the porosity of the solids is modified and partially clogged by deposits of various natures (organic or mineral impurities). The solid can then be regenerated/cleaned by injecting high-pressure air or by heating to a high temperature (greater than 100° C.) in the presence of air. In the latter case, solids that are stable at high temperature will be preferred.

The solids used in the context of the present invention are generally in the form of crystals of size less than 100 μm (largest dimension) as measured by scanning electron microscopy.

The mesoporous solids used in the context of the present invention may consist of a single type of crystal or a mixture of crystals of different mesoporous solids, for example of different chemical composition or sizes, in order to optimise the performance of the mesoporous solid and/or its thermal and mechanical properties. When the mesoporous solid is made up of a mixture of crystals, the fabrication of the solid can consist of homogeneous or heterogeneous mixtures of various crystals. For example, when the solid is deposited on a support, which can be porous, it is possible to deposit a plurality of successive layers of different crystals.

The mesoporous solids used in the context of the present invention can be synthesised by any method known to a person skilled in the art. For example, the mesoporous solids can be prepared by sol-gel, precipitation or hydrothermal methods, which are generally followed by a heat treatment. The aluminium-oxide-based solids can be prepared according to the synthesis methods described in FR2080526, FR2282863, U.S. Pat. Nos. 3,322,495, 4,016,108, WO2001038252, US20180208478, U.S. Pat. No. 6,511,642 and US20140161716. The silicon-oxide-based solids can be prepared according to the methods described in U.S. Pat. No. 5,958,577, US20100272996, US20110081416 and U.S. Pat. No. 5,094,829. The oxides containing a plurality of chemical elements can be prepared according to the methods described in US20140367311, US20070010395 and U.S. Pat. No. 5,260,251. The mesostructured solids, in other words those for which the mesopores have a uniform morphology and dimensions and which are distributed periodically with respect to one another, can be prepared according to one of the methods disclosed by Naik et al. (A Review on Chemical Methodologies for Preparation of Mesoporous Silica and Alumina Based Materials, Recent Patents on Nanotechnology, Volume 3, Issue 3, 2009, 213-224) and Wu et al. (Synthesis of mesoporous silica nanoparticles, Chem. Soc. Rev., 2013, 42, 3862-3875). The carbon-based solids can be prepared according to the methods as described in US20100021366.

The mesoporous solids advantageously enable control for the desired relative humidity values, ranging from 20% to 97%.

The relative humidity can be measured by a capacitive, resistive or gravimetric hygrometer.

Mesoporous solids having a mean pore diameter on adsorption ranging from 10 to 40 nm and a mean pore diameter on desorption ranging from 10 to 35 nm, are preferably chosen in order to control the relative humidity at values ranging from 80% to approximately 95%.

Mesoporous solids having a mean pore diameter on adsorption ranging from 5 to 15 nm and a mean pore diameter on desorption ranging from 5 to 13 nm, are preferably chosen in order to control the relative humidity at values ranging from 60% to approximately 80%.

Mesoporous solids having a mean pore diameter on adsorption ranging from 3 to 10 nm and a mean pore diameter on desorption ranging from 3 to 9 nm, are preferably chosen in order to control the relative humidity at values ranging from 40% to approximately 60%.

### Implementation of the Mesoporous Solids

In order to adapt to the outside climate and to the desired optimum hygrometry inside the enclosed space, various implementations of the mesoporous solid are possible. In general, all the implementations that make it possible to place the mesoporous solid in contact with the air of the enclosed space can be used.

Depending on the use of the enclosed space and the desired levels of relative humidity, the mass of mesoporous solid to be implemented per unit volume of air can vary from 0.003 kg/m³ to 0.8 kg/m³.

The first possible implementation simply consists of placing the mesoporous solid inside the enclosed space. So as to avoid humidity gradients, it is not recommended to place all of the solid at the same place, but rather to disperse it throughout the entire enclosed space or to ensure a circulation of air in the enclosed space, for example using fans. The mesoporous solid can be placed in any suitable type of container (for example, boxes, bags, nets, etc.).

A second possible implementation is placing the mesoporous solid in one or more containers made of a material that is impermeable to air and provided with openings connected to the atmosphere of the enclosed space. In this case, the interior air is injected into the containers, for example using a fan, where it is placed in contact with the mesoporous solid, and from which it emerges with a controlled relative humidity. This implementation enables a more homogeneous relative humidity of the enclosed space and makes it possible to reach the desired relative humidity more quickly. For this implementation, it is possible to use the air coming from inside or outside the enclosed space in order to regenerate the solid. When the air comes from outside the enclosed space, it can be heated or cooled beforehand by circulation inside the enclosed space, or by any other available means (air/ground heat exchanger or solar heating, for example).

For these two first implementations, the mesoporous solid is preferably used in the form of crystal agglomerates of millimetre order of magnitude, for example agglomerates for which the size varies from 0.1 to 10 mm (the size designates the size of the largest dimension when the agglomerates are not spherical). Such agglomerates are easier to handle than crystals in powder form. The agglomerates can be shaped by extrusion, granulation, pressing or any other process known to a person skilled in the art. Binders or additives, for example clay or polymers, can be added in order to improve the cohesion of the crystals to one another and thus to obtain agglomerates that are more stable mechanically. According to the shaping processes chosen, the agglomerates can be of various shapes (spherical, cylindrical, platelets, etc.). The shape and size of the agglomerates are typically chosen so as to maximise the adsorption/desorption kinetics of the water in the agglomerates. Thus, agglomerates which have a high “outer surface/volume” ratio will be favoured, such as spherical, cylindrical, trilobal, quadrilobal agglomerates, of size less than 5 mm. Larger objects, such as monoliths, are therefore not recommended. The mesoporous solid can likewise be deposited on a support. The support can control the shape and the mechanical strength of the resultant product. Large solids (greater than one centimetre) can thus be prepared. They can be transported easily and have large contact surface areas with the air.

For the second implementation, the solid can also be used in the form of membranes, made of pure solid or of solid deposited on a porous support, the membrane being a selective barrier enabling the separation of fluids in the presence of a driving force, in the present case the relative humidity gradient. For more details concerning membranes and membrane processes, refer to the article by Abdullah et al., Chapter 2—Membranes and Membrane Processes: Fundamentals, Editor(s): Angelo Basile, Sylwia Mozia, Raffaele Molinari, Current Trends and Future Developments on (Bio-) Membranes, Elsevier, 2018, Pages 45-70. In this configuration, the inside air will be placed in contact with one side of the membrane and the air used for the regeneration will be placed in contact with the other side of the membrane. The membranes can be tubular, planar or even spiral. A plurality of membrane modules can be used in series or in parallel. Part of the effluent from one or more membrane modules will be able to be recycled at the inlet of one or more modules, on the humid air side or on the side of the air used for regeneration. When a plurality of membrane modules is used, it is advantageous to place them upstream or downstream of the heat exchanger modules, in order to better control the temperature in the system. In the case where the enclosed space is already provided with a ventilation system, for example controlled mechanical ventilation (CMV) for residential spaces, the membrane module can be coupled with this system.

A third possible implementation consists of placing the mesoporous solid in one or more surfaces defining the enclosed space, for example in one or more walls, or even in all the walls, in the floors and/or ceilings of the enclosed space. Typically, contact of the mesoporous solid with the outside air is ensured. In this third implementation, most particularly when the mesoporous solid is placed in the walls, the mesoporous solid is generally shaped so as to form a continuous homogeneous layer between the inside and the outside of the enclosed space. Such a continuous homogeneous layer can avoid air leaks. The mesoporous solid can be shaped alone or be deposited in or on the surface of a porous support. The wall thus obtained can consist of one or more layers, in order to ensure mechanical strength and thermal resistance. Thus, the thermal insulation of the wall can be reinforced by introducing a layer of stagnant air to the interior of the support.

When humidity control is particularly useful at a specific location in the room (for example close to plants in the case of agricultural greenhouses, or in particularly humid areas in residential and industrial buildings), advantageously the solid can be placed close to these locations. Thus, in agricultural greenhouses, the solid is preferably placed at least 10 metres from the plants, yet more preferably at least 5 metres, and particularly preferably at least 2 m from the plants. In agricultural greenhouses, it is desirable to make maximum use of the energy provided by solar radiation. Consequently, the solid is preferably placed so that it does not prevent solar radiation from reaching the plants. In buildings for residential use, the solid is preferably placed in the humid rooms, such as bathrooms and kitchens.

Thus, the present invention also relates to a process for controlling relative humidity in an enclosed space comprising the following steps:
(a1) placing the mesoporous solid inside the enclosed space, preferably at different locations in the enclosed space; or
(a2) placing the mesoporous solid in one or more containers made of a material that is impermeable to air and provided with openings connected to the atmosphere of the enclosed space, the containers being placed in the enclosed space; or
(a3) placing one or more devices as described above or below, inside the enclosed space; or
(a4) placing the mesoporous solid in one or more surfaces (e.g. walls, floors, ceilings) of enclosed spaces.

The mesoporous solid can be as described above. In steps (a1), (a2) and (a4), the mesoporous solid can be in free form, for example in the form of granules, or the mesoporous solid can be deposited on a support. The mesoporous solid can be disposed in any suitable type of container.

The mesoporous solid or the device is typically left in place for a period of at least 10 days. The process for controlling the relative humidity in an enclosed space can therefore comprise the following steps:
(a) (a1) placing the mesoporous solid inside the enclosed space, preferably at different locations in the enclosed space; or
   (a2) placing the mesoporous solid in one or more containers made of a material that is impermeable to air and provided with openings connected to the atmosphere of the enclosed space, the containers being placed in the enclosed space; or
   (a3) placing one or more devices as described above or below, inside the enclosed space; or
   (a4) placing the mesoporous solid in one or more surfaces (e.g. walls, floors, ceilings) of enclosed; and
(b) leaving the solid or the device in place for a period of at least 10 days.

In step (b), the solid or the device can be kept in place for a period ranging from 10 days to several months or even several years, for example one month, three months, six months, one year, two years.

### Devices

The present invention also relates to a device for controlling the relative humidity in an enclosed space. The device comprises:
a container;
a mesoporous solid disposed in the container.

The mesoporous solid is as described above.

In further embodiments, the container is made of a material that is impermeable to air and provided with one or more openings intended to be connected to the atmosphere of the enclosed space. The container is impermeable to air due to the choice of material. Nevertheless, the container comprises one or more openings enabling control of the relative humidity of the air of the enclosed space. In certain embodiments, the container comprises as sole opening(s), the one or more openings intended to connect the interior of the container with the atmosphere of the enclosed space, in which the device is/will be installed In other embodiments, the container can also comprise openings enabling it to be connected to the outside of the enclosed space enabling circulation of the air coming from outside the enclosed space in order to regenerate the solid.

### Uses

The mesoporous solids described above can be used for controlling the relative humidity of any type of enclosed spaces, for example any type of building (cultivation greenhouse, agricultural buildings dedicated to the storage or drying of foodstuffs and plants, buildings for residential use or for professional use, production workshop, covered swimming pools, saunas, hammams, museums, etc.) or other enclosed spaces such as transport buildings.

According to the enclosed space, the control needs, and in particular the minimum and maximum values of humidity desired, can differ. The properties of the mesoporous solid, its shaping and its implementation can be modified in order to adapt to these constraints. The mesoporous solids described above advantageously enable control for desired relative humidity values ranging from 20% to 97%.

This capacity to control the humidity over different relative humidity ranges will be demonstrated using the examples below.

The examples which follow are given by way of illustration. These examples in no way limit the present invention.

### EXAMPLES

### Solids

The properties of the various solids used in the examples below are detailed in Table 1.

The mesoporous solids have been synthesised according to the methods described above.

TABLE 1
properties of various solids

| | Total | | | Macroporous | Mean | Mean | [Mean pore | |
|---|---|---|---|---|---|---|---|---|
| | macroporous | | | volume/total | diameter | diameter | diameter at | |
| | and | | | macroporous | of the | of the | desorption]/ | |
| | mesoporous | Mesoporous | Microporous | and mesoporous | mesopores at | mesopores at | [mean pore | |
| | volume | volume | volume/ | volume | adsorption | desorption | diameter at | Chemical |
| Ref. | (mL/g) | (mL/g) | (mL/g) | (—) | (nm) | (nm) | adsorption] | composition |
| A | 1.13 | 1.13 | 0 | 0 | 29.2 | 20.7 | 0.71 | Al₂O₃ |
| B | 0.95 | 0.95 | 0 | 0 | 9.2 | 7.3 | 0.79 | SiO₂ |
| C | 0.94 | 0.94 | 0 | 0 | 22.9 | 17.4 | 0.76 | SiO₂ |
| D | 0.70 | 0.70 | 0 | 0 | 14.0 | 9.7 | 0.69 | Al₂O₃ |
| E | 1.26 | 1.26 | 0 | 0 | 9.7 | 9.3 | 0.96 | SiO₂ |
| F | 0.34 | 0.01 | 0.27 | 0.97 | — | — | — | Na₂₉Al₅₈Si₁₃₄O₃₈₄ |
| G | 0.52 | 0.25 | 0 | 0.52 | 2.2 | 2.2 | 1 | SiO₂ |
| H | 0.79 | 0.79 | 0 | 0 | 5.2 | 3.7 | 0.71 | SiO₂ |
| I | 0.61 | 0.61 | 0 | 0 | 4.1 | 3.6 | 0.88 | SiO₂ |
| J | 0.72 | 0.72 | 0 | 0 | 8.5 | 6.2 | 0.73 | SiO₂ |
| K | 0.73 | 0.73 | 0 | 0 | 15.2 | 4.2 | 0.28 | Al₂O₃ |
| L | 0.75 | 0.75 | 0 | 0 | 15 | 5.3 | 0.35 | Al₂O₃ |
| M | 0.72 | 0.72 | 0 | 0 | 15.5 | 11 | 0.71 | Al₂O₃ |

The nitrogen adsorption-desorption isotherms were measured at −196° C. using a commercial apparatus (Auto Sorb 1, Quantachrome Corporation). Before the measurement, the samples are regenerated under secondary vacuum at 350° C.

The total macroporous and mesoporous volume are measured by mercury intrusion using an Autopore IV 9500 mercury porosimeter from Micromeritics.

Solids A-E and H-J are mesoporous solids used in the context of the present invention. Solids F and G are not according to the invention. Solid F is a zeolite (mainly microporous), its mesoporous volume is less than 0.2 mL/g. The mean mesopore diameter of solid G is less than 3 nm.

Solids K, L and M have mesoporous volumes and equivalent mean diameters at adsorption, but different mean diameters at desorption.

Solid K is not according to the invention because it has a “mean mesopore diameter as measured by nitrogen desorption”/“mean mesopore diameter as measured by nitrogen adsorption” ratio less than 0.3.

### Example 1

The objective was to control the relative humidity in a greenhouse for tomato production in the south of France. The surface area of the ground of greenhouse is 960 m² and its total volume is 6048 m³. The greenhouse contains 3 tomato plants per m². It is equipped with openings to enable air to enter from outside, as well as heating tubes supplied with hot water by a gas boiler. In order to avoid condensation on the leaves, it is desired that the relative humidity in the greenhouse is always less than 90%.

The relative humidity in the greenhouse in the presence and absence of the following solids between day D, 06:00 and D+2, 12:00 was compared
Solid C;
Solid D;
Solid F;
Solid G;
Mixture of solids C and D (50% by mass solid C, 50% by mass solid D);
Mixture of solids C and E (50% by mass solid C, 50% by mass solid E);
Mixture of solids C, D and E: (33.3% by mass solid C, 33.3% by mass solid D, 33.3% by mass solid E);

The solids are in the form of cylindrical particles of 1 mm diameter and approximately 5 mm length.

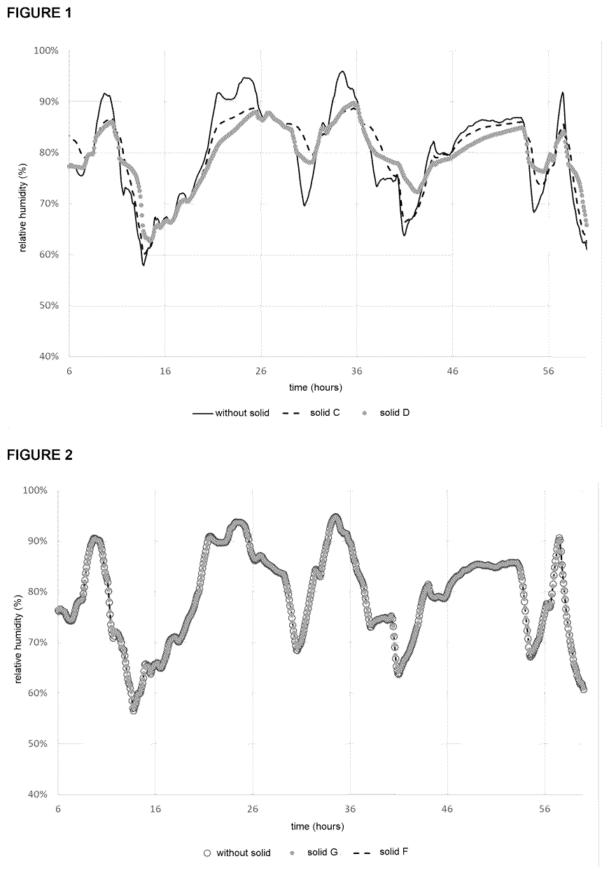

FIG. 1 shows the relative humidity over time in the absence of solid and with 200 kg of solids C and D.

FIG. 2 shows the relative humidity over time in the absence of solid and with 200 kg of solids F and G (not according to the invention).

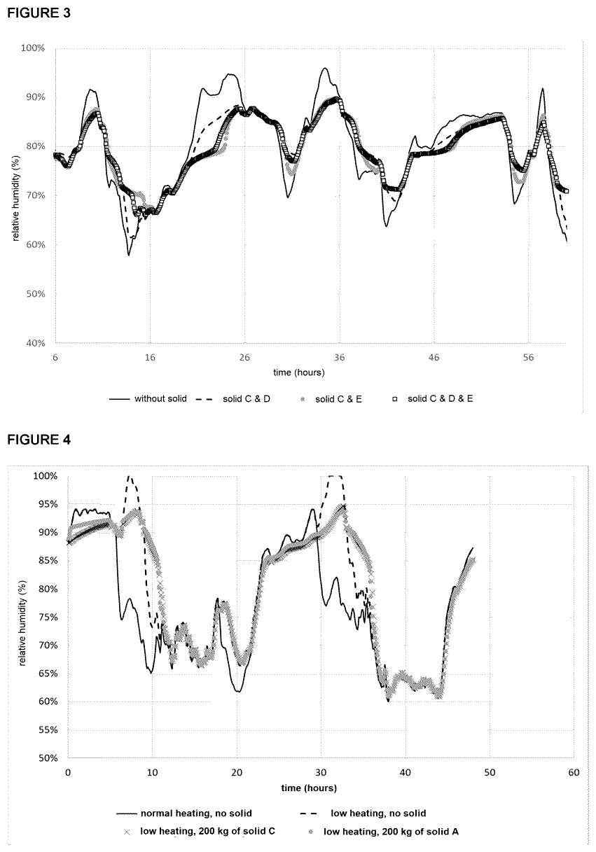

FIG. 3 shows the relative humidity over time in the absence of solid and with 200 kg of mixtures of solids (C+D, C+E, C+D+E).

It was observed that in the absence of solid, the relative humidity was greater than 90% at several times over the time period studied. The addition of a solid or of a mixture of solids according to the invention made it possible to never exceed the threshold of 90%, whereas the addition of solids not according to the invention did not change the evolution of the relative humidity over time.

### Example 2

In the same greenhouse as described for example 1, the objective was to avoid too high relative humidities, but also to reduce the energy expenditure generated by heating. The maximum relative humidity is therefore fixed at 94% and the possibility of limiting the maximum temperature of the heating tubes to 30° C. between 00:00 on day D and 00:00 on day D+2 was studied.

In conventional configuration, in other words with an unlimited heating power, the total energy used during this period is 5519 kWh. By limiting the heating, a consumption of 4373 kWh is observed, i.e. a reduction in energy expenditure of 21%.

FIG. 4 compares the relative humidity during this period under normal conditions (normal heating), with temperature limitation (low heating) but without solid and finally with temperature limitation and in the presence of 200 kg of solids A and C. The shape and the implementation of the solids are the same as for example 1. It can be noted that in the absence of solid, the reduction of the heating power leads to a significant increase in the relative humidity in the greenhouse at certain times of the day, and even to condensation of a part of the vapour on day D and day D+1 at 08:00 in the morning (8 hours and 32 hours in FIG. 4). By contrast, in the presence of solids A and C, it is possible to reduce the heating power while avoiding the problems of condensation.

### Example 3

A different implementation of the solids was tested in the same greenhouse and for the same period as for example 2. The solids are placed in the two cylindrical containers. Flexible ducts are attached to the two ends of the containers, enabling air to be circulated between the solid particles. The circulation of air is produced using fans. At the outlet and inlet of the containers, two 3-way valves enable two operating modes to be alternated. In adsorption mode, the inlet and outlet of the container are connected to the inside of the greenhouse. In regeneration mode, the inlet and outlet of the container are connected to the outside of the greenhouse, via an opening in its wall, 50 cm above ground level. The diameter of the containers is 1 m and their length is 2 m.

The process is in adsorption mode between 06:00 and 09:00 on day D and between 05:00 and 08:00 on day D+1, and in regeneration mode between 12:00 and 17:00 on days D and D+1. The remainder of the time, the fans are switched off and the valves closed.

The flow rates of the fans are fixed at different values according to the solids: 4000 m³/h for solids A and D, 5000 m³/h C, F and G and 6000 m³/h for solid E.

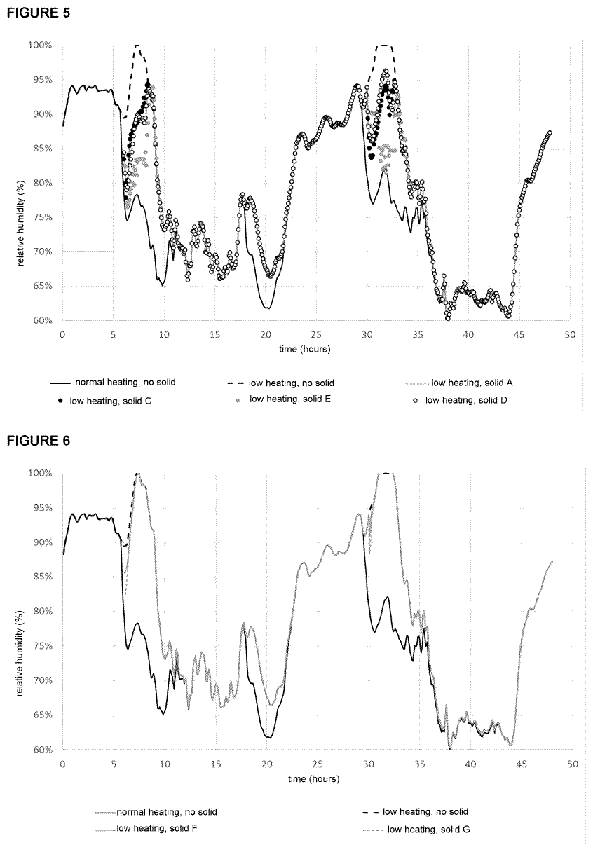

FIG. 5 compares the relative humidity over time under normal conditions (normal heating), with temperature limitation (low heating) but without solid and finally with temperature limitation and the various solids A, C, E and D, implemented as described above.

FIG. 6 is identical to FIG. 5, except that the solids implemented are solids G and F (not according to the invention).

It is observed that with this implementation, solids A, C, E and D make it possible to control the humidity in order to avoid condensation in the greenhouse, whereas solids G and F have almost no impact on the relative humidity in the greenhouse.

### Example 4

The objective was to control the relative humidity in an office located in Paris (France). In order to ensure the comfort of the occupants, the relative humidity must be between 40% and 70%.

The bureau has a floor area of 12 m², a height to the ceiling of 2.5 m and has controlled mechanical ventilation enabling the total renewal of the inside air in 1.4 hours. The office is occupied from 08:00 in the morning to 18:00.

The solid is implemented in the form of a square plate of 2.5 cm thickness and with sides of 100 cm, fixed to the office ceiling.

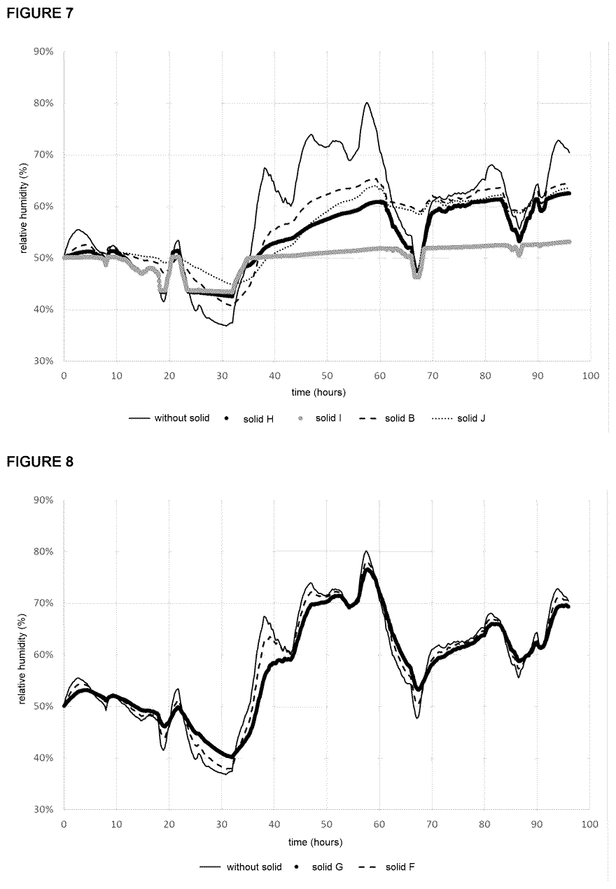

FIG. 7 makes it possible to compare the relative humidity in the office between the 00:00 on day D and 00:00 on D+4, without solid and with solids B, H, I and J.

FIG. 8 is identical to FIG. 7 for solids G and F (not according to the invention).

In the absence of solid or with solids G and F, the relative humidity regularly leaves the defined range for good comfort of the occupants. By contrast, in the presence of solids B, H, I and J, the relative humidity is controlled between 40% and 70%.

### Example 5

In Paris, and in the same period as for example 4, solids were implemented for controlling the relative humidity in an apartment comprising a living space including a living room and a kitchen, and three bedrooms.

The apartment has a floor area of 105 m², a height to the ceiling of 2.4 m and has controlled mechanical ventilation enabling the total renewal of the inside air in 1.4 hours. The apartment is occupied every day between 18:00 and 08:00 in the morning.

The solid is implemented in the form of 5 square-shaped plates of 2.5 cm thickness and with sides of 110 cm. One plate is fixed to the ceiling of each bedroom and two plates are fixed to the ceiling of the living space.

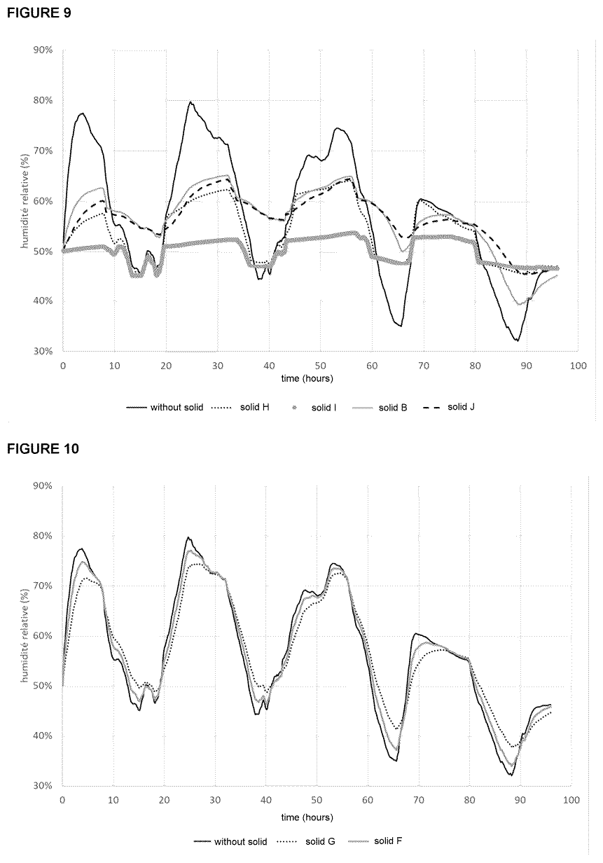

FIG. 9 makes it possible to compare the relative humidity in the apartment between the 00:00 on day D and 00:00 on D+4, without solid and with solids B, H, I and J.

FIG. 10 is identical to FIG. 9 for solids G and F (not according to the invention).

FIG. 9 and FIG. 10 show that the solids B, H, I and J can control the relative humidity in the apartment at between 40% and 70%, which is not the case for solids G and F.

### Example 6

In the same greenhouse as described for example 1, the objective was to control the relative humidity therein, in such a way that it was always less than 90%.

The relative humidity in the greenhouse in the presence and absence of the following solids between midnight on day D and 16:00 on D+4, was compared in the presence of
Solid K;
Solid L;
Solid M.

The solids are in the form of cylindrical particles of 1 mm diameter and approximately 5 mm length.

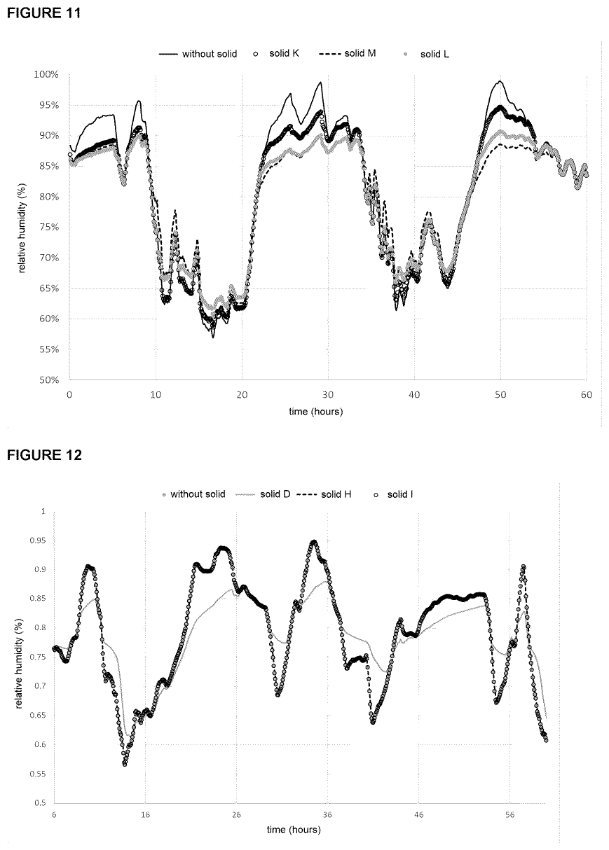

FIG. 11 shows the relative humidity over time in the absence of solid and with 500 kg of solids K, L and M.

It was observed that in the absence of solid, the relative humidity was greater than 90% at several times over the time period studied. The addition of solids L and M used in the context of the invention makes it possible to never exceed the threshold of 90%, which is not the case for solid K which is not according to the invention.

### Example 7

In the same greenhouse as described for example 1, the objective was to control the relative humidity therein, in such a way that it was always less than 90%.

The relative humidity in the greenhouse in the presence and absence of the following solids between midnight on day D, and 16:00 on D+4, was compared in the presence of
Solid D;
Solid H;
Solid I.

The solids are in the form of cylindrical particles of 1 mm diameter and approximately 5 mm length.

All the solids are according to the invention, but are not recommended for controlling in the same relative humidity ranges:
solid I has a mean diameter at adsorption of 4.1 nm, thus less than 5 nm and is therefore recommended for controlling relative humidities relatives between 40 and 60%,
solid H has a mean diameter at adsorption of 5.2 nm and is therefore recommended for controlling relative humidities between 40 and 80%,
solid D has a mean diameter at adsorption of 14 nm and is therefore recommended for controlling relative humidity between approximately 75 and 95%,

The average value of the relative humidity in the greenhouse during this period is 79%, the minimum value is 57% and maximum value 95%.

FIG. 12 shows the relative humidity over time in the absence of solid and with 200 kg of solids D, H and I.

Table 2 shows the average, minimum and maximum relative humidity values in the greenhouse during this period.

TABLE 2
average, minimum and maximum relative humidity values
in the greenhouse during this period, with or without solid

| | without | | | |
|---|---|---|---|---|
| | solid | D | H | I |
| mean | 79% | 79% | 79% | 79% |
| Max | 95% | 88% | 95% | 95% |
| Min | 57% | 61% | 57% | 57% |

It can be seen that the two solids H and I, the diameters of which at adsorption are less than 6 nm, are not suitable for controlling the relative humidity in the greenhouse at the desired level.

Solid D, for which the diameter at adsorption is greater than 10 nm, can be used to control the relative humidity between 61 and 88%.

### Example 8

The regeneration capacity of various porous solids in the absence of addition of external energy, was evaluated for a relative humidity range between 90% and 75%.

A “DVS Advantage” apparatus from Micromeritics was used, which enables a weighing of the mass of the solids under controlled relative humidity and temperature. The measurements are carried out at 25° C. The solids are firstly dried for 3 hours under dry air (relative humidity less than 1%). Then the relative humidity of the air is increased to 90% and when the variation in mass over time is less than 1%, the mass of the solid is noted. The relative humidity of the air at 75% is then calculated and the same measurement is carried out. Then, the percentage of water absorbed is calculated as a function of the dry mass of solid, according to the following calculation:

Quantity of water adsorbed (% by mass)=(mass of the solid at relative humidity of 90% (resp. 75%)-mass of the dry solid)/mass of the dry solid.

The regeneration capacity of the solid is equal to the quantity of water adsorbed at relative humidity of 90%−quantity of water absorbed at relative humidity of 75%.

The results obtained are recorded in Table 3

TABLE 3
regeneration capacities of various solids at 25° C.
between 90% and 75% relative humidity

| | capacity for | capacity for | | Mean |
|---|---|---|---|---|
| | a relative | a relative | | mesopore |
| | humidity | humidity | Regeneration | diameter at |
| | of 90% | of 75% | capacity | adsorption |
| solid | (% mass) | (% mass) | (% mass) | (nm) |
| 1 | 60.0 | 35.0 | 25.0 | 8.2 |
| 2 | 52.0 | 38.0 | 14.0 | 6.8 |
| D | 70.0 | 33.6 | 36.4 | 14 |
| C | 84.6 | 18.8 | 65.8 | 22.9 |
| J | 68.4 | 66.2 | 2.2 | 8.5 |
| H | 78.2 | 76.6 | 1.6 | 5.2 |
| I | 61.0 | 58.6 | 2.4 | 4.1 |
| B | 92.8 | 72.0 | 20.8 | 9.2 |
| E | 123.5 | 121.0 | 2.5 | 9.7 |
| K | 54.75 | 11.388 | 43.4 | 15.2 |
| L | 56.2 | 10.2 | 46.0 | 15 |
| M | 59.7 | 10.8 | 48.9 | 15.5 |

Solids 1 and 2 are solids as described in JP2002284520A.

It is observed that the solids characterised by mean mesopore diameters at adsorption greater than 10 nm have the best regeneration capacities when the relative humidity is reduced from 90% to 75%,

### Example 9

The same experiments were carried out as for example 8, but for relative humidities of 60% and 40%. The results are noted in Table 4.

TABLE 4
regeneration capacities of various solids at 25° C.
between 60% and 40% relative humidity

| | capacity for | capacity for | | Mean |
|---|---|---|---|---|
| | a relative | a relative | | mesopore |
| | humidity | humidity | Regeneration | diameter at |
| | of 60% | of 40% | capacity | adsorption |
| solid | (% mass) | (% mass) | (% mass) | (nm) |
| D | 18.9 | 13.3 | 5.6 | 14 |
| C | 15.0 | 12.2 | 2.8 | 22.9 |
| J | 34.6 | 28.8 | 5.8 | 8.5 |
| H | 75.1 | 52.9 | 22.1 | 5.2 |
| I | 56.1 | 15.9 | 40.3 | 4.1 |
| B | 38.8 | 25.6 | 13.3 | 9.2 |
| E | 45.4 | 35.3 | 10.1 | 9.7 |
| K | 8.0 | 5.3 | 2.8 | 15.2 |
| L | 8.3 | 5.3 | 3.0 | 15 |
| M | 7.8 | 5.2 | 2.6 | 15.5 |

It is observed that the solids characterised by mean mesopore diameters at adsorption less than 10 nm have the best regeneration capacities when the relative humidity is reduced from 60% to 40%.

1. A use of mesoporous solids for controlling the relative humidity in an enclosed space, said mesoporous solid having:
mesopores, the mean diameter of which varies from 3 to 50 nm as measured by nitrogen adsorption combined with the BJH method according to standard ASTM D4641-17;
a mesoporous volume greater than or equal to 0.2 mL/g as measured by nitrogen adsorption combined with the BJH method according to standard ASTM D4641-17; and
a ratio between the mean diameter of the mesopores as measured by nitrogen desorption and as measured by nitrogen adsorption ([desorption mean diameter]/[adsorption mean diameter]) ranging from 0.3 to 1;
wherein when the mesoporous solid also comprises macropores, micropores or micropores and macropores:
the total macroporous and mesoporous volume varies from 0.3 to 2 mL/g;
the ratio (macroporous volume)/(total macroporous and mesoporous volume) is less than 0.6; and
the microporous volume is less than 0.2 mL/g.

2. The use according to claim 1, wherein the mesoporous solid has mesopores, the mean diameter of which varies from 3 to 50 nm as measured by nitrogen desorption combined with the BJH method according to standard ASTM D4641-17.

3. The use according to claim 2, wherein the mesoporous solid has a “mean diameter of the mesopores as measured by nitrogen desorption”/“mean diameter of the mesopores as measured by nitrogen adsorption” ratio ranging from 0.4 to 1.

4. The use according to one of the preceding claims, wherein the mesoporous solid is selected from the group comprising metal oxide-based solids, carbon-based solids and the mixtures thereof.

5. The use according to claim 4, wherein the mesoporous solid is selected from the group comprising the oxides of silicon, the oxides of aluminium, active carbon, carbon nanotubes and the mixtures thereof.

6. The use according to one of the preceding claims, wherein the enclosed space is a cultivation greenhouse, an agricultural building dedicated to storage or drying of foodstuffs and plants, a building for residential use or professional use, a production workshop, a covered swimming pool, a sauna, a hammam, a museum or a transport building.

7. The use according to one of the preceding claims, wherein the mesoporous solid has a mean pore diameter on adsorption ranging from 10 to 40 nm and a mean pore diameter on desorption ranging from 10 to 35 nm, enabling the relative humidity to be controlled at values ranging from 80% to approximately 95%.

8. The use according to one of the preceding claims, wherein the mesoporous solid has a mean pore diameter on adsorption ranging from 5 to 15 nm and a mean pore diameter on desorption ranging from 5 to 13 nm, enabling the relative humidity to be controlled at values ranging from 60% to approximately 80%.

9. The use according to one of the preceding claims, wherein the mesoporous solid has a mean pore diameter on adsorption ranging from 3 to 10 nm and a mean pore diameter on desorption ranging from 3 to 9 nm, enabling the relative humidity to be controlled at values ranging from 40% to approximately 60%.

10. The use according to one of the preceding claims, wherein the mesoporous solid has zero microporous volume.

11. The use according to one of the preceding claims, wherein the mesoporous solid is in the form of agglomerates.

12. The use according to one of the preceding claims, wherein the mesoporous solid is in the form of crystals of size less than 100 μm as measured by scanning electron microscopy.

13. A device for controlling the relative humidity in an enclosed space, comprising:
a container, preferably a container made of a material that is impermeable to air, and provided with one or more openings intended to be connected to the atmosphere of the enclosed space;
a mesoporous solid disposed in the container, said mesoporous solid being as defined in claim 1.

14. A process for controlling the relative humidity in an enclosed space comprising one of the following steps:
(a1) placing the mesoporous solid as defined in claim 1 inside the enclosed space; or
(a2) placing the mesoporous solid as defined in claim 1 in one or more containers made of material that is impermeable to air and provided with openings connected to the atmosphere of the enclosed space inside the enclosed space; or
(a3) placing one or more devices according to claim 13 inside the enclosed space; or
(a4) placing the mesoporous solid as defined in claim 1 in one or more surfaces of the enclosed space.

15. The process according to claim 14 wherein the mesoporous solid or the device is left in place for a period of at least 10 days.

16. The process according to claim 14 or 15, wherein the enclosed space is a cultivation greenhouse, an agricultural building dedicated to storage or drying of foodstuffs and plants, a building for residential use or professional use, a production workshop, a covered swimming pool, a sauna, a hammam, a museum or a transport building.
